(19) United States
(12) Patent Application Publication
(10) Pub. No.: US 2001/0013066 A1
(43) Pub. Date: Aug. 9, 2001

(54) Route optimization over diverse media

(76) Inventors: Paul Andrew Erb, Ottawa (CA); Andrew Ian Duncan, Stittsville (CA)

Correspondence Address: Marks & Clerk, P.O. Box 957, Station B, Ottawa, ON, K1P 5S7, CA

(21) Appl. No.: 09/773,593

(22) Filed: Feb. 2, 2001

(30) Foreign Application Priority Data
Feb. 4, 2000 (GB) 0002500.7

(51) Int. Cl. G06F 15/16

(52) U.S. Cl. 709/228; 709/238

(57) ABSTRACT

A system and method of optimizing route selection of a communication connection over diverse media are described. The diverse media include but are not limited to the Public Switched Telephone Network (PSTN), a Wide Area Network (WAN), a Virtual Private Network (VPN), and satellite transmission. A desktop such as a computer is associated with one or more end system terminals. The desktop stores tables which identify the selection of available media and optimization factors associated with each. Set up and tear down protocols for each media are also stored by the desktop. Tables containing routing preferences for each media is also maintained at the desktop. Upon connection initiation the available media is evaluated for optimum service in relation to a callers set of preferences. A reroute of the connection after initiation can be implemented if a preferred route becomes available.

### FIELD OF THE INVENTION

The present invention is related to connection oriented communications and, more particularly, to systems and methods for optimizing such communications over diverse media.

### BACKGROUND

The transmission of voice, video and data communication between remote end system terminals has taken on considerable significance in recent years. Concomitant with the increased traffic comes the need to obtain optimized service including quality of service and cost reductions. The cost reduction issue has been addressed by both private and public networks, such as the Public Switched Telephone Network (PSTN), wherein calls or connections are initially set up over a “least cost” route. Additionally, the connection may be rerouted to take advantage of a cheaper alternate route that becomes available during a call. Typically, the rerouting is done after a preset time has elapsed. An example of this is a Digital Private Network Signaling System (DPNSS) private network signaling for route optimization.

In circuit switched networks in general, non-optimal routes are detected during call establishment by the originating or transit PBX node. In addition, an original optimal route can be changed as the result of a user invoked feature such as call transfer. Detection of non-optimal routes and changes to routes trigger route optimization attempts at periodic intervals during the established call phase. One example of a route optimization system involving PBX switching equipment, is described in U.S. Pat. No. 5,325,422, which issued Jun. 28, 1994 to David J. Ladd. One of the features described in the 5,325,422 patent is route optimization which provides automatic selection of the least cost route for outgoing calls. The patent also discloses a call queuing function which provides that when a least cost route is not available, there is an automatic call back to a user when the route does in fact become available.

The PSTN remains a common media for low bandwidth communication including voice and data. There has been, however, considerable recent advances in communication technology which has led to alternate transmission modes including the Wide Area Network (WAN), Virtual Private Networks (VPN), wireless and satellite networks as well as high speed cable access utilizing fibre optics.

When diverse media such as the above are involved, the route optimization supported in a single media standard does not apply except within the same selected media. Once a media connection is established, no mechanism exists to determine if the route taken is optimal and, if not, select a sufficiently better route from all of the available media. Nor is there a mechanism to seamlessly reroute the media connection to take advantage of a better route during the call.

In Local Area Networks (LAN), routes of the least quantity of hops are calculated and maintained similarly to that performed by packet networks. Each of these systems operates independently and without interaction with each other. In packet networks, each packet node maintains routing tables which list the routes to every other node based on the least quantity of network hops. These tables are updated dynamically as network links are established and deactivated.

U.S. Pat. No. 5,825,772 which issued Oct. 20, 1998, to Dobbins et al., relates to a packet switched data communication network which provides path determination and call rerouting functionality. As in the case of the PSTN, this path determination and rerouting capability applies to the packet switched network and does not accommodate diverse media.

In fact, none of the existing systems for route optimization known by the applicants herein provides feedback to the user, nor does it inform their users of the status of a route utilized by a particular connection. Further, none of these known systems provides a mechanism whereby a call or communication connection is established based on the optimum media chosen from a selection of available media.

Under the various systems in operation at the present time users determine, on placing a call or a media communication, which media they wish to use in order to complete the call. If the call does not succeed on a first attempt, they might try to place a call over an alternative media. Once the call has been established it is up to the users to determine if they wish to select or switch to a more optimal media. To accomplish this, a user would end the call, usually prematurely, and make a new call attempt in hopes of achieving a more optimal connection.

Accordingly, there is a need for a system in which optimization of a connection is provided for a caller by employing the transmission media which will insure the best service.

The present invention satisfies this need by providing a desktop associated with a caller's terminal wherein the desktop has lookup tables for storing lists of available media and optimization factors for each media. The look up tables also include set up and tear down protocols for each media.

Therefore, in accordance with the first aspect of the present invention there is provided a method of selectively routing communication connections through diverse media comprising: providing a computer associated with a first end system; providing a lookup table in the computer, the lookup table storing a selection of media options for routing a communication connection to a second end system, the lookup table further including optimization factors and connection protocols for each media option; and accessing the lookup table to select a media for routing the connection based on the optimization factors.

The diverse media referred to above, may include but is not limited to the wide area network, a public switched telephone network, telephone over cable, virtual private network satellite and wireless networks.

In accordance with a second aspect of the present invention there is provided a system for selectively routing communication connections between first and second end systems through diverse media comprising: computing means associated with the first end system; a lookup table in the computing means, the lookup table storing a list of media options available for routing a communication connection from the first end system to the second end system, and optimization factors and connection protocols for each listed media option; and accessing means to access the lookup table to select one of the media options for routing a connection based on the optimization factors.

### BRIEF DESCRIPTION OF THE DRAWINGS

The invention will now be described in greater detail having reference to the attached drawings wherein:

FIG. 1 is a high level drawing showing the system architecture for diverse communication between end systems;

FIG. 2 is a lookup table displaying media options and stored factors; and

FIG. 3 shows a table of media options and service preferences for use in optimization.

### DETAILED DESCRIPTION OF THE INVENTION

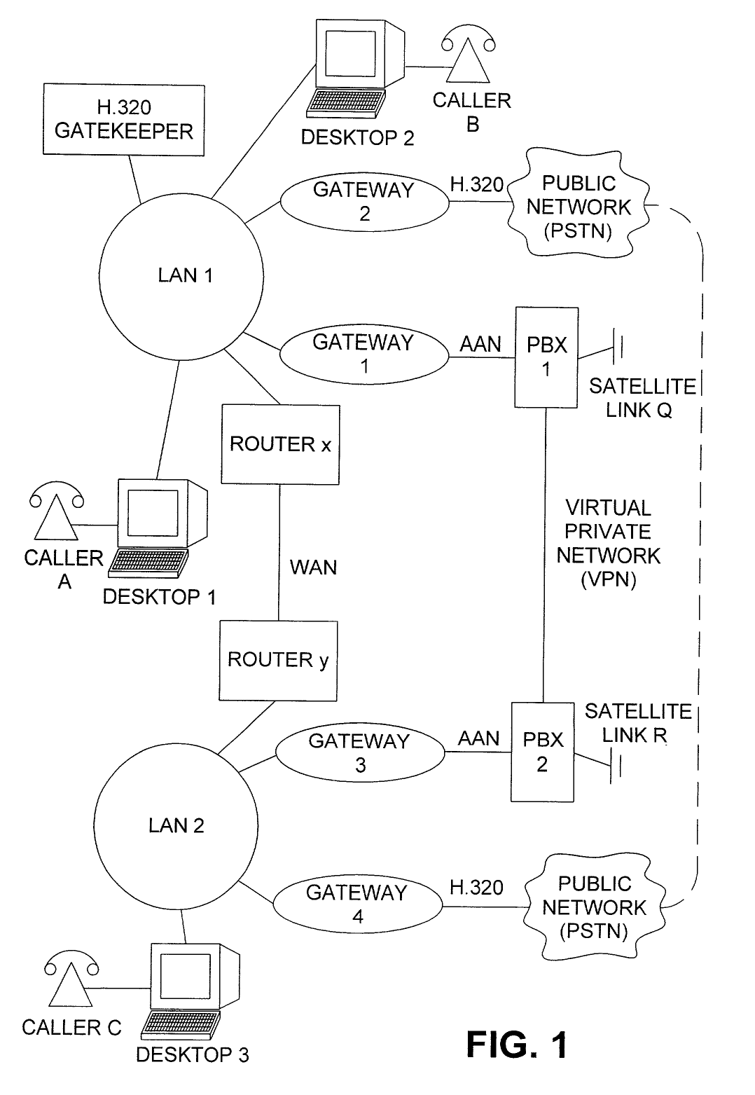

FIG. 1 shows, at a high level, certain components required to implement the present invention. In this exemplary implementation, caller A located in LAN 1 desires to place a telephone call to terminal C in LAN 2. Desktop 1 is associated with caller A and desktop 3 is associated with terminal C. In FIG. 1, caller A and a user of terminal C are shown to be using a traditional telephone. It is to be understood that other terminals such as modems, facsimile equipment and video equipment may also be used. The desktop equipment i.e. desktop 1 and desktop 3, in a preferred embodiment is a PC or similar computer having conventional processing equipment and memory capacity for storing relevant data. While the desktops in the preferred embodiment are computers, it will be apparent to one skilled in the art that other processing equipment, whether dedicated or multi-purpose, can be used and, in fact, the desktop may be integrated into an end system terminal.

As shown, LAN 1 includes connections to multiple transmission media by way of gateways, routers and gatekeepers. It will also be apparent that the stored information required to implement the present invention may alternatively be stored in a server associated with a gatekeeper or gateway, etc.

LAN 2, to which terminal C is connected, is also connected to various access ports including gateways and routers. The various gateways and routers provide a selection of potential media connections including: a wide area network (WAN) connected by way of router X and router Y; and a Virtual Private Network (VPN) interconnected by gateway 1 to PBX 1 and from PBX 2 to gateway 3 to LAN 2. Transmission between the PBX connections may also be by way of a satellite link involving antennas Q and R. Also shown in FIG. 1 is the traditional public switched telephone network connected through gateway 2 and gateway 4.

The gateways provide the necessary translation protocols to convert the traffic stream into the proper format for communicating via the selected media.

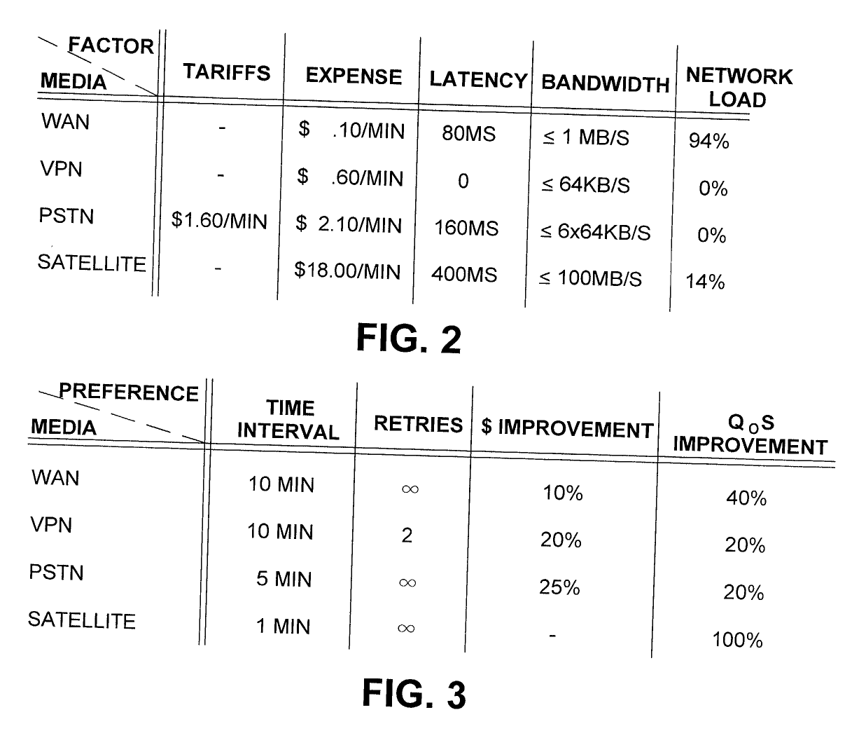

According to the present invention, each desktop or selected desktops maintains a table such as table A shown in FIG. 2, that includes a list of available media which may be used to complete a connection between respective callers. As shown in FIG. 2, the media selection includes: a WAN; a VPN; the PSTN and a satellite. Other media connections can be included, but table A is only intended as an example selection. Also shown in table A (FIG. 2), are the respective static and dynamic optimization factors. These factors include: tariff; per minute expense, latency, bandwidth available, and the network load. Also stored in table A, but not shown in FIG. 2, are the associated call setup and tear-down protocols for each of the listed diverse media. Table A is updated periodically from available sources. For example, the tariff charges may be available from Web pages. The table is also updated from end to end quality tests performed automatically, or as initiated or configured by the user. The end to end quality tests will be discussed later.

The desktop also maintains a second table, namely table B as shown in FIG. 3. Table B includes the list of media options set out in Table A and a list of user preferences which include the time interval between the call attempts, the number of retries during a call, the cost improvement required before initiating a rerouting, and the quality of service improvement required in order to initiate a reroute. Table B may also include a list of calling line I.D.'s for which high or low quality connections are required or acceptable.

Upon initiation of a connection, the desktop attempts to establish a call by selecting a transmission media from the available diverse media in order of preference. In the event a non-optimal media connection is obtained, an indication of such is presented to the user. The user may opt to proceed with the non-optimal media with the option of selecting a reroute when a better connection becomes available. This reroute selection may be delayed by a set period of time after the call is initiated, or selected on a periodic basis during the time of the connection. Assuming the user selects the periodic evaluation, the desktop will determine, at intervals, whether an alternative route is available and whether the route is better than the established connection media. The evaluation also determines whether the new route satisfies the user's preferences as set out in table. B. In the event a satisfactory alternative route is available the desktop will attempt to establish a new call on the selected media. The route optimization attempt is recognizable to the far end as a second media connection with the same originator. If the receiving device at the remote destination recognizes the route, the new connection is tested for suitability using a media file that reflects the active communication. As noted before, the communication may include audio, video or data communication. Therefore, the test involves a media file that corresponds to the type of communication carried by the connection at the time and may be, for example, an audio clip or a video clip. The test result is compared against the quality of the existing media connection, and if there is an improvement which meets the preference criteria, as shown in table B, the new route will be selected.

If the receiving desktop does not recognize the route optimization attempt, the new connection is not tested for suitability. Table B is used to determine whether the new media connection is to be accepted in the absence of test results.

It should be pointed out here that the receiving terminal does not need to have a desktop associated with it as it is typically the desktop of the calling party that selects and monitors the connection.

If the new media connection is accepted, the user is given an indication of the route optimization success, and the desktop associated with the user's terminal switches the call seamlessly to the new media connection. The old media connection is then dropped.

As noted above, the selection of an optimal route can also depend on the calling line I.D. of the called party. Depending on the type of communication involved, certain preferred customers may require a higher quality of service than others. This information can be stored in table B and used in determination of an acceptable route.

By way of an exemplary implementation, assume that a caller at location A wishes to place a call to caller at location C to discuss an important issue. The desktop associated with location A establishes a media communication across the satellite link between PBX 1 and PBX 2. Location A's desktop presents the user with an indication that an expensive route has been selected and no alternative route is available due to disruption in the alternative systems. After a period of time, say for example, two minutes, location A's desktop determines that a WAN connection is available and establishes a media connection without interfering with the existing voice communication. Location C's desktop recognizes the second call from location A's desktop and initiates a suitability test using an audio clip. Due to congestion on the WAN, the suitability test fails to meet latency minimums and the WAN connection is dropped. After another period of time say, for example, three minutes, location A's desktop determines that the public network is available and again establishes a media connection to location C's desktop. As before, location C's desktop recognizes the second call from location A's desktop and again initiates a suitability test using an audio clip. The test is successful and due to a cost difference of 200%, the new connection is accepted. Without interruption, the audio streaming is redirected to the PSTN connection and the more expensive satellite linkage is dropped. Location A's desktop may continue to periodically attempt to make a WAN connection at a preset interval say, five minutes, until the call terminates.

Route optimization may be accomplished on behalf of the user by a proxy desktop implemented in a gatekeeper, gateway or in a server in the event that the user's device does not support this feature. In addition to the optimization factors listed above, further criteria can be used to measure and select between optimal groups. Additional variations or implementations could involve the augmentation of signaling mechanisms. These would involve changes to private and public protocols to provide feedback on connection quality. Private circuit switched network protocols may be extended to provide user indication of non-optimal route selection and allow the user an opportunity to control when route optimization is attempted. Many circuit switched networks will not attempt route optimization for data error capabilities to prevent momentary loss of data. However, in a diverse network, if the user's desktop is informed, the inherent store and forward capabilities of other network types on the desktop could be utilized to perform circuit switched route optimization of data calls without loss of data. Additionally, the LAN gateway protocols could be extended to provide an indication to the user desktop when non-optimal PSTN connections are utilized. This information could augment the desktop's tables A and B information for route optimization. Further, LAN and sub-net protocols could be extended to provide packet delay feedback to desktop thereby enabling users to select higher or lower quality of service.

While preferred embodiments of the present invention have been described and illustrated it will be apparent that numerous variations to the basic concepts can be implemented. It is to be understood, however, that such variations will fall within the true scope of the invention as defined by the appended claims.

1. A method of optimizing a communication connection by providing a desktop with data for use in route selection.

2. The method of claim 1 wherein said data includes a selection of available media for routing said communication connection.

3. The method of claim 2 wherein said data includes optimizing factors relating to each available media.

4. The method of claim 1 wherein said desktop is a computer associated with a communications terminal at a source end of said communication connection.

5. A method of selectively routing communication connections through diverse media comprising:
providing a computer associated with a first end system;
providing a lookup table in said computer, said lookup table storing a selection of media options for routing a communication connection to a second end system, said lookup table further including optimization factors and connection protocols for each media option; and
accessing said lookup table to select a media for routing said connection based on said optimization factors.

6. The method of claim 5 wherein said diverse media is selected from the group consisting of a Wide Area Network (WAN), Public Switched Telephone Network (PSTN), Telephone over Cable, Virtual Private Network (VPN), Satellite and Wireless networks.

7. The method of claim 5 wherein said first and second end systems comprise telephone terminals.

8. The method of claim 7 wherein said communication is voice communication.

9. The method of claim 5 wherein said first and second end systems include video terminals.

10. The method of claim 5 wherein said lookup table includes dynamic and static optimization factors associated with each media option.

11. The method as defined in claim 10 wherein said optimization factors are selected from the group consisting of tariffs, expense, latency, bandwidth and network load.

12. The method of claim 5 further including the step of providing means to monitor a connection and to reroute the connection in the event another one of the media options can provide a better service.

13. The method of claim 12 wherein said means monitors the connection at a set time after a connection has been set up.

14. The method of claim 12 wherein said means monitors the connection on a periodic basis.

15. The method of claim 11 wherein said connection is tested by sending a media file to a second end system and obtaining a comparison of the present connection with characteristics of said media file.

16. The method of claim 15 wherein said end systems are for voice communication and said media file is an audio clip.

17. The method of claim 15 wherein said end systems are for video communication and said media file is a video clip.

18. The method of claim 16 wherein said comparison sets an improvement level of a second media option with the current connection and a switch to a new media is made only if the difference in service exceeds the improvement level.

19. The method of claim 5 wherein said lookup table identifies a selected media for routing a connection based on the identity of the second end system.

20. A system for optimizing a communication connection between communication terminals, said system having a desktop associated with one terminal for storing route selection information.

21. A system as defined in claim 20 wherein said route selection information includes a selection of communication media available for routing said connection.

22. A system as defined in claim 20 wherein said route selection information includes optimization factors relating to each available communication media.

23. A system as defined in claim 21 wherein said route selection information is stored in lookup tables in said desktop.

24. A system for selectively routing communication connections between first and second end systems through diverse media comprising:
computing means associated with said first end system;
a look up table in said computing means, said lookup table storing a list of media options available for routing a communication connection from said first end system to said second end system and optimization factors and connection protocols for each listed media option; and
accessing means to access said look up table to select one of said media options for routing a connection based on said optimization factors.

25. A system as defined in claim 24 wherein said diverse media includes a Public Switched Telephone Network (PSTN), a Wide Area Network (WAN), a Virtual Private Network (VPN) and a satellite transmission network.

26. A system as defined in claim 24 wherein said accessing means includes means to reroute a connection after initiation if a new connection better matching a users preferences becomes available.

27. A system as defined in claim 22 wherein said route selection information is stored in lookup tables in said desktop.
